(19) United States
(12) Patent Application Publication
(10) Pub. No.: US 2010/0073923 A1
(43) Pub. Date: Mar. 25, 2010

(54) LED LAMP ASSEMBLY

(75) Inventor: YOU-XUE LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/235,612

(22) Filed: Sep. 23, 2008

(51) Int. Cl. F21V 7/00

(52) U.S. Cl. 362/228

(57) ABSTRACT

An LED lamp assembly includes a lamp supporter, a plurality of first and second lamps supported by the lamp supporter and a reflecting cover located above and covering the lamp supporter. The lamp supporter includes a hollow post, a plurality of bars radially connected to the post and a plurality of hollow cylinders connected to the bars, respectively. Each cylinder has a plate located inside thereof to divide an inside of the each cylinder into two parts. The first and second lamps are mounted on two opposite surfaces of the plates of the cylinders, respectively. The reflecting cover has a surface facing and being slantwise to the first lamps to provide a large range of reflection.

### BACKGROUND OF THE INVENTION

1. Field of the Invention

The present invention relates to a lamp assembly, and more particularly relates to an LED lamp assembly for lighting and decorating purposes.

2. Description of Related Art

An LED lamp assembly is a type of solid-state lighting that utilizes light-emitting diodes (LEDs) as a source of illumination. An LED is a device for transferring electricity to light by using a theory that, if a current is made to flow in a forward direction through a junction region comprising two different semiconductors, electrons and holes are coupled at the junction region to generate a light beam. The LED has an advantage that it is resistant to shock, and has an almost eternal lifetime under a specific condition; thus, the LED lamp assembly is intended to be a cost-effective yet high quality replacement for incandescent and fluorescent lamps.

Due to advantages of the LED, the LED lamp is widely used for outdoor lighting and decorating purposes.

What is needed, therefore, is an improved LED lamp assembly for lighting and decorating purposes.

### SUMMARY OF THE INVENTION

A LED lamp assembly includes a lamp supporter, a plurality of first and second lamps supported by the lamp supporter and a reflecting cover located above and covering the lamp supporter. The lamp supporter includes a hollow post, a plurality of bars radially connected to the post and a plurality of hollow cylinders connected to the bars, respectively. Each cylinder has a plate located inside thereof to divide an inside of the each cylinder into two parts. A first and second lamps are mounted on two opposite surfaces of the plate of each of the cylinders, respectively. The reflecting cover has a surface facing and being slantwise to the first lamps to provide a large range of reflection.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of an LED lamp assembly engaging with a supporting post in accordance with a preferred embodiment of the present invention.

FIG. 2 is an exploded view of FIG. 1.

FIG. 3 is an enlarged view of the lamp assembly of FIG. 1 without a reflecting cover.

FIG. 4 is a cross-section view of FIG. 3, taken along line IV-IV thereof.

### DETAILED DESCRIPTION OF THE INVENTION

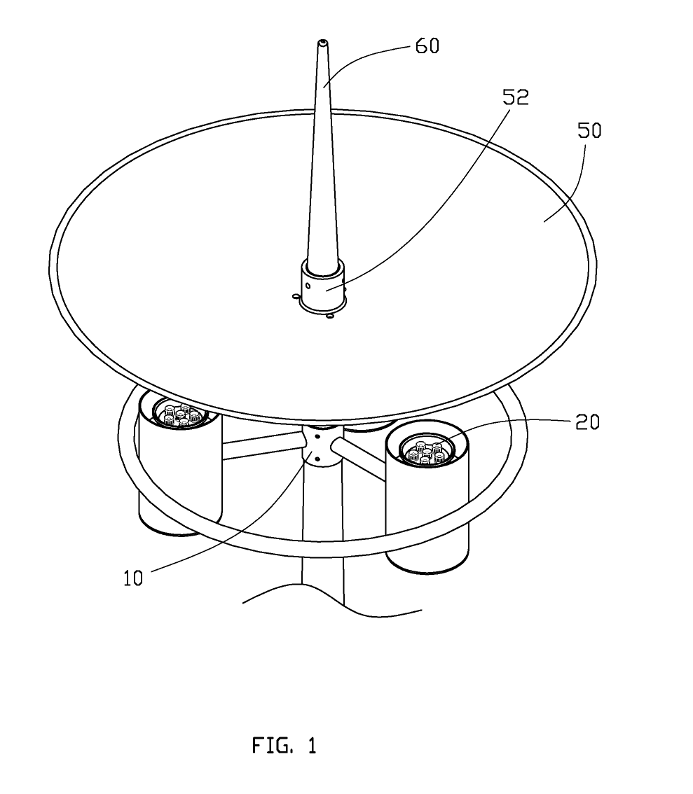

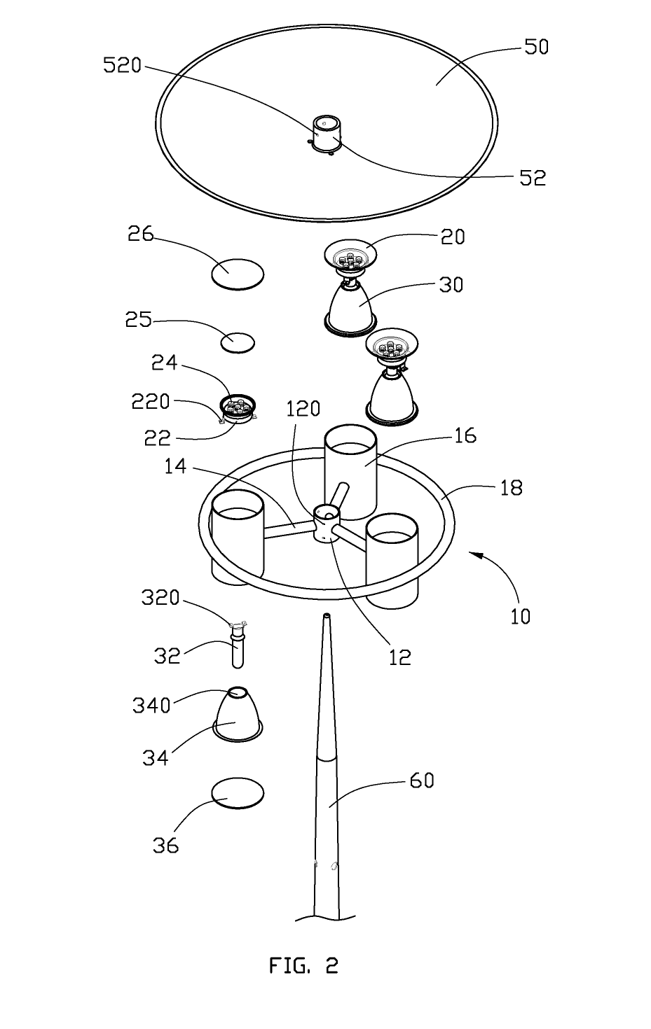

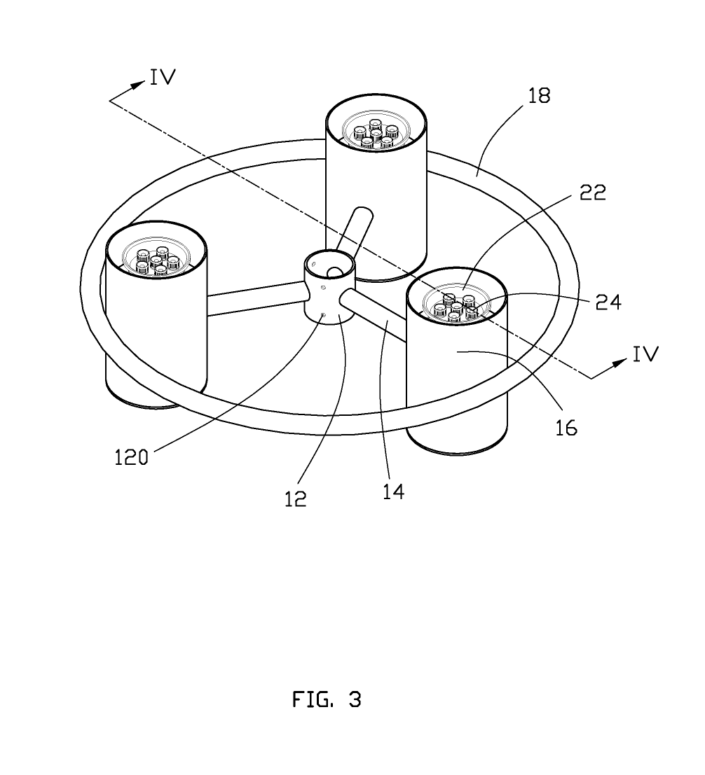

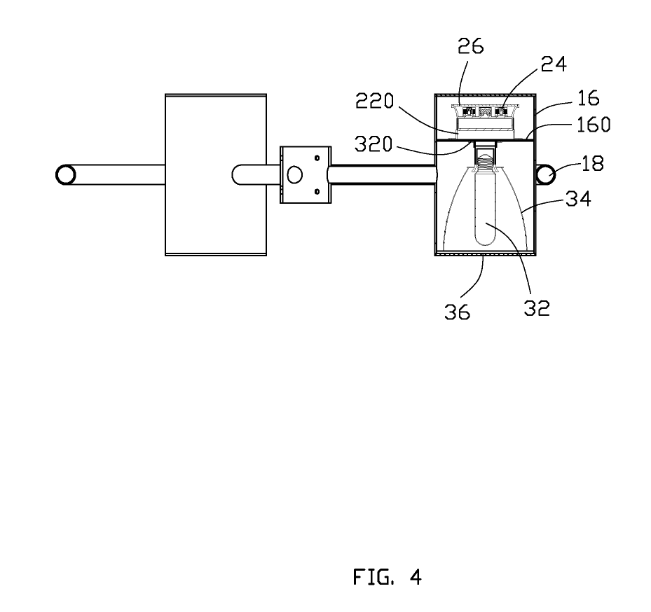

Referring to FIGS. 1-4, an LED lamp assembly for outdoor lighting and decorating purposes in accordance with a preferred embodiment of the present invention is shown. The lamp assembly comprises a lamp supporter 10, first and second lamps 20, 30 supported by the lamp supporter 10. The first lamp 20 is an LED module for lighting and decorating purposes and the second lamp 30 is a conventional lamp for a lighting purpose. In other embodiment, the second lamp 30 can be an LED module instead of the conventional lamp. The lamp assembly further comprises a reflecting cover 50 located above the lamp supporter 10 and covering the lamp supporter 10, the first and second lamps 20, 30. The lamp assembly can be held at a predetermined position by a supporting post 60 engaging with the lamp supporter 10. In this embodiment, the reflecting cover 50 is mounted downwardly around the supporting post 60 and engages with the supporting post 60 to be mounted above the lamp supporter 10.

The lamp supporter 10 comprises a hollow post 12 located in a center thereof. A plurality of mounting holes 1 20 are defined in a circumferential sidewall of the hollow post 1 2, for extension of fasteners (not shown) therethrough to mount the hollow post 1 2 to the supporting post 60 when the supporting post 60 extends through the hollow post 1 2. Three bars 14 are radially connected to the hollow post 12 at a circumferential sidewall of the hollow post 12. Three hollow cylinders 16 are connected to free ends of the connecting bars 1 4, respectively. A circular plate 1 60 is located inside each cylinder 1 6 and perpendicularly to an axis of the each cylinder 16, for mounting the first and second lamps 20, 30 at two opposite surfaces of the plate 1 60. Thus, the first and second lamps 20, 30 are received in two compartments of the each cylinder 16 divided by the circular plate 160. An annular guardrail 18 surrounds the three cylinders 1 6 and is tightly attached to circumferential sidewalls of the cylinders 1 6, thereby enhancing stability of the cylinders 1 6 relative to the hollow post 12.

Three first lamps 20 are received in respective cylinders 16 and each are located over a corresponding plate 1 60 in the respective cylinder 1 6. Each first lamp 20 comprises a dish-shaped holder 22 and a plurality of LEDs 24 received in the holder 22 and mounted on a top surface of the holder 22. A pair of feet 220 extends from two opposite lateral sides of a lower portion of the holder 22 and is mounted on a top surface of the plate 160 of a corresponding cylinder 16 so as to secure the corresponding first lamp 20 in a top portion of an inside of the cylinder 16. An envelope 25 covers on a top of the holder 22 and another bigger envelope 26 covers on a top of the corresponding cylinder 16 to prefect the LEDs 24 from damage and contamination. The envelope 26 is made of transparent or semitransparent material such as glass and colophony. The envelope 26 is configured to be snugly received in the corresponding cylinder 16 and cling to an inner wall of the top of the corresponding cylinder 1 6.

Three second lamps 30 are received in the cylinders 1 6 and are mounted on lower surfaces of the plates 160 and opposite to the first lamps 20, respectively. Each second lamp 30 comprises a conventional lamp 32, such as one of HID, incandescent and fluorescent lamps, and a cup-shaped reflecting housing 34 for accommodating the conventional lamp 32 therein. The reflecting housing 34 defines a circular opening 340 in a top thereof for extension of a corresponding conventional lamp 32 therethrough. The conventional lamp 32 has a lower portion extending through the opening 340 and received in the reflecting housing 34 and a top portion exposed outside of the reflecting housing 34 to engage with the lower surface of the plate 160 of the corresponding cylinder 16. A pair of feet 320 is formed at two opposite lateral sides of the top portion of the conventional lamp 32 and mounted on the lower surface of the plate 160 of the corresponding cylinder 16. An envelope 36 covers a bottom of the reflecting housing 34 to protect the conventional lamp 32 from damage and contamination. The reflecting housing 34 is used as a reflector and light emitted by the conventional lamp 32 is reflected by the reflecting housing 34 to travel through the envelope 36 to illuminate a surrounding environment. The second lamps 30 are accommodated in the lower portions of the respective cylinders 16 so that the light emitted by the conventional lamps 32 can illuminate downwardly towards ground to satisfy a requirement of a long-distance lighting.

The reflecting cover 50 has a shape substantially like a disc and comprises an inner surface facing and being slantwise to the first lamps 20 to provide a large range of reflection. A hollow pipe 52 extends upwardly from a center of the reflecting cover 50, for extension of the supporting post 60 therethrough. A plurality of fixing orifices 520 is defined in a circumferential sidewall of the pipe 52, for extension of fixtures (not shown) therethrough to secure the reflecting cover 50 to the top portion of the supporting post 60.

In this embodiment of the present invention, the first and second lamps 20, 30 received in the inside of the cylinders 16 of the lamp supporter 10 are separately mounted on two opposite surfaces of the plates 1 60 of the cylinders 1 6, respectively, whereby the first and second lamps 20, 30 are separately controlled by different electric circuits. Thus, any one of the first and second lamps 20, 30 which does not work will not influence the other one. The first and second lamps 20, 30 can simultaneously provide upward and downward illumination to satisfy requirement of outdoors decorating and lighting purposes or only provide one of the upward and downward illumination according to actual demands.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp assembly, comprising:
a lamp supporter comprising a hollow post adapted for engaging with a supporting pole to secure the lamp supporter to the supporting pole, a plurality of bars connected to the post and a plurality of hollow cylinders connected to the bars, respectively, each hollow cylinder comprising a plate located inside thereof and dividing an inside of the each hollow cylinder into two parts;
a plurality of first lamps each received in a corresponding cylinder and mounted on a first surface of the plate of the corresponding cylinder; and
a plurality of second lamps each received in a corresponding cylinder and mounted on a second surface opposite to the first surface of the plate of the corresponding cylinder;
a reflecting cover for engaging with the supporting pole to secure the reflecting cover to the supporting pole, the reflecting cover being located above the lamp supporter and having a surface facing and being slantwise to the first lamps.

2. The lamp assembly as claimed in claim 1, wherein the first lamps are LED modules and the second lamps are lamps other than LED lamps.

3. The lamp assembly as claimed in claim 2, wherein the plate of the each cylinder is located perpendicular to an axis of the each cylinder.

4. The lamp assembly as claimed in claim 3, wherein the bars are radially connected to the post.

5. The lamp assembly as claimed in claim 4, wherein the lamp supporter further comprises an annular guardrail tightly attached to sidewalls of the cylinders.

6. The lamp assembly as claimed in claim 2, wherein the first lamps each comprise a holder and a plurality of LEDs mounted on the holder.

7. The lamp assembly as claimed in claim 6, wherein the holder of each first lamp comprises a pair of feet mounted on the first surface of the plate of a corresponding cylinder.

8. The lamp assembly as claimed in claim 6, wherein the second lamps each comprise a cup-shaped reflecting housing surrounding a corresponding second lamp.

9. The lamp assembly as claimed in claim 8, wherein the second lamps each comprise a pair of feet mounted on the second surface of the plate of a corresponding cylinder.
